(19) United States
(12) Patent Application Publication
(10) Pub. No.: US 2024/0092020 A1
(43) Pub. Date: Mar. 21, 2024

(54) HARDENED BUILD PLATFORM FOR USE IN THREE-DIMENSIONAL PRINTING SYSTEMS

(71) Applicant: SprintRay, Inc., Los Angeles, CA (US)

(72) Inventors: Huijian Tian, Los Angeles, CA (US); Aayush Patel, Los Angeles, CA (US); Anjali E. Daniels, Los Angeles, CA (US); Hossein Bassir, Los Angeles, CA (US)

(21) Appl. No.: 18/370,105

(22) Filed: Sep. 19, 2023

Related U.S. Application Data
(60) Provisional application No. 63/408,067, filed on Sep. 19, 2022.

(51) Int. Cl. B29C 64/245; B33Y 30/00

(52) U.S. Cl. CPC B29C 64/245; B33Y 30/00; B29C 64/124

(57) ABSTRACT

A hardened build platform for use in three-dimensional (3D) printing systems employing photosensitive resins with suspended ceramic particles. The build platform includes a build surface that includes a layer of material with a Mohs hardness rating that is equal to or greater than the Mohs hardness rating of the ceramic particles suspended in the photosensitive resin. The layer of hardened material includes anodized aluminum, ceramic, or glass. The build surface also may be roughened to increase the adhesion between the 3D printed part and the hardened build surface.

### FIELD OF THE INVENTION

This invention relates to three-dimensional (3D) printing systems, including a build platform with a hardened build surface.

### BACKGROUND

Three-dimensional (3D) printing systems utilize photosensitive resins to form 3D printed parts. The 3D printed parts are formed directly onto a build surface of a build platform emersed in the photosensitive resin.

However, some photosensitive resins are highly viscous and include suspended ceramic particles to product ceramic 3D printed parts. The suspended ceramic particles, having a higher Mohs hardness rating than that of the build platform's build surface, may cause micro-scratches on the build surface during the flow of the resin, which in turn may dislodge small particles of the build surface's material into the resin thereby contaminating the resulting 3D printed part.

Accordingly, there is a need for a build platform with a hardened build surface. Additionally, there is a need for a hardened build surface that includes a Mohs hardness rating that is equal to or greater than the Mohs hardness rating of the ceramic particles with the photosensitive resin being used.

### SUMMARY

According to one aspect, one or more embodiments are provided below for a build platform for use in a three-dimensional (3D) printing system employing photosensitive resin with particle suspensions, the particles including a first Mohs hardness rating, the build platform comprising a build platform including a build surface including a second Mohs rating, the second Mohs rating equal to or greater than the first Mohs rating.

In another embodiment, the particles include ceramic particles and the first Mohs rating is about 7.5, and the build surface includes anodized aluminum and the second Mohs rating is about 9.0.

In another embodiment, the anodized aluminum is a Type III anodization.

In another embodiment, a thickness of the anodized aluminum is about 13 μm to 150 μm.

In another embodiment, the build surface is roughened to increase a surface area of contact between the build surface and a 3D printed part.

In another embodiment, the build surface is roughened to include a roughness rating RA of about 0.5 μm to 10 μm.

The presently disclosed orthodontic bracket and bracket support system and its method of manufacture and use is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIGS. 1-4 show a build platform within a resin tank partially filled with a resin in accordance with exemplary embodiments hereof;

FIGS. 5-6 show a build platform within a resin tank partially filled with a resin including suspended ceramic particles in accordance with exemplary embodiments hereof;

FIG. 7 shows a build platform with a hardened build surface within a resin tank partially filled with a resin including suspended ceramic particles in accordance with exemplary embodiments hereof; and

FIGS. 8A-8B show a build platform with a hardened layer in accordance with exemplary embodiments hereof.

### DETAILED DESCRIPTION OF EXEMPLARY EMBODIMENTS

In general, the system and method according to exemplary embodiments hereof includes hardened build surface for use with 3D printing systems.

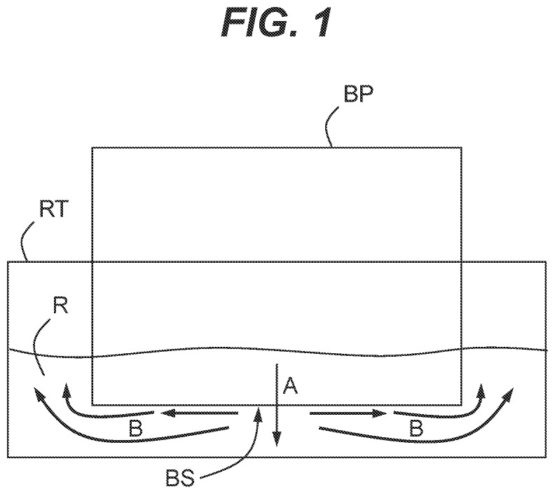

FIG. 1 shows a standard build platform BP including a bottom build surface BS immersed within a resin tank RT filled with resin R for use with three-dimensional (3D) printing systems. The build platform BP and its build surface BS comprise aluminum (or hard plastic), being a lightweight material with sufficient hardness to support the object being 3D printed during the printing process.

At the onset of the 3D printing process, the build platform BP is lowered into the resin tank RT as indicated by the arrow A until its build surface BS is spaced above the bottom surface of the resin tank RT by a distance generally equal to the thickness of a desired 3D printed layer. During this downward motion, the resin R in contact with the build surface BS is pushed downward and forced to flow outwards across the build surface BS until the positioning is complete. This resin flow is represented by the arrows B.

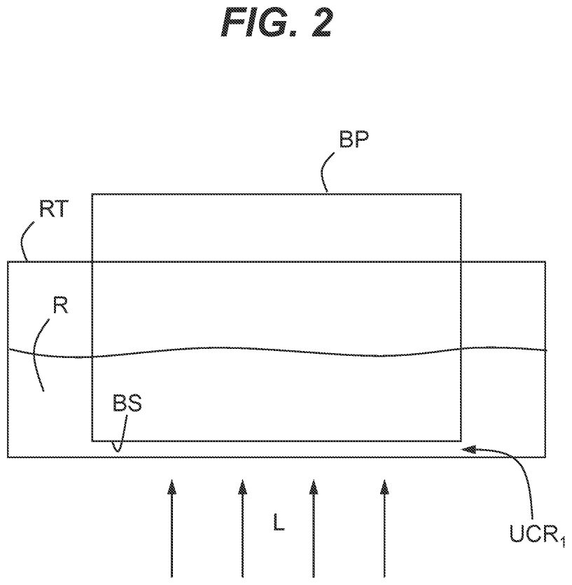

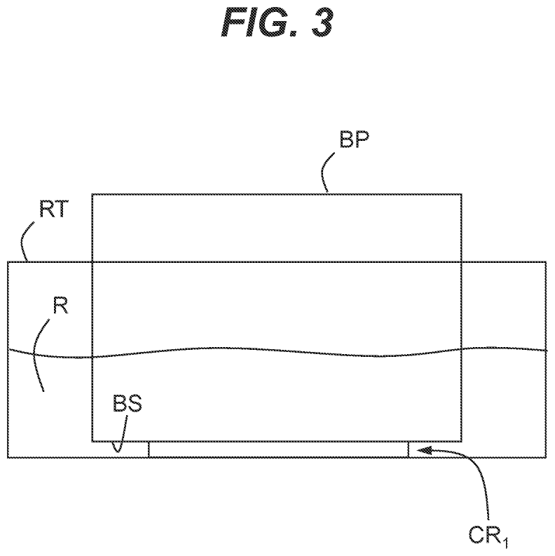

As shown in FIG. 2, once the build platform BP is properly positioned, a first layer of uncured resin UCR₁ exists between the build surface BS and the bottom side of the tank RT. A first pattern of curing light L is radiated through the bottom side of the resin tank RT to cure (i.e., harden) the first layer of uncured resin UCR₁ into a first layer of cured resin CR). This first layer of cured resin CR) is formed as the shape of the first pattern of light L and is cured directly onto the build surface BS. As such, the first layer CR) is attached directly to the build surface BS. This is shown in FIG. 3.

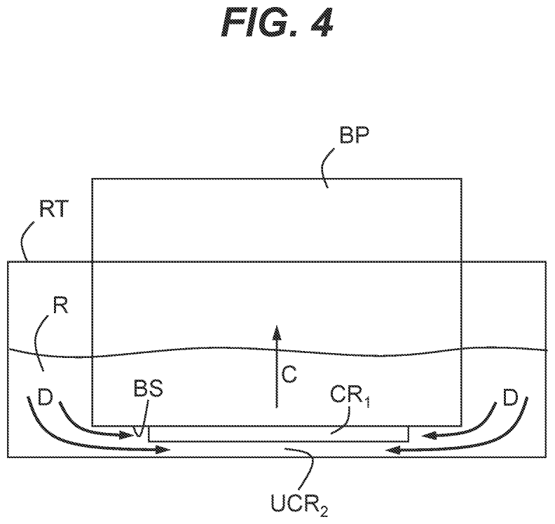

Next, as shown in FIG. 4, the build platform BP is raised upward as indicated by the arrow C to force a second layer of uncured resin UCR₂ to flow into the area between the bottom surface of the first layer of cured resin CR1 and the bottom surface of the tank RT. In this scenario, the resin flows from the sides of the build platform BP down and across the platform's build surface BS and into the area beneath the first layer of cured resin CR1 as indicated by the arrows D. Once the flow of uncured resin is complete, a second pattern of curing light L is radiated through the bottom side of the tank RT to cure the second layer of uncured resin into a second layer of cured resin. The second layer of cured resin is formed as the shape of the second pattern of light L and is cured directly onto, and therefore attached directly to, the bottom surface of the first layer of cured resin CR1. This process may be repeated (e.g., hundreds or thousands of times) to build the desired object layer-by-layer until the entire object is formed, with each movement of the build platform BP causing a corresponding movement of the resin R across the platform's build surface BS.

After the 3D printing process has been completed, the build platform BP is lifted out of the resin tank RT and the object is removed from the build surface BS. This removal is typically performed by scraping the object from the build surface BS using a sharp blade. Because the cured resin comprising the object is softer (less hard) than the build surface BS comprising aluminum and the scraping blade used to remove the object, the object is easily removed, and the build surface BS is undamaged by this process.

A wide range of materials may be 3D printed using systems and procedures similar to those described above. For instance, photopolymers used in 3D printing resins may include polymer bases such as acrylics, epoxies, polyvinyl alcohol, polyvinyl cinnamate, polyisoprene, polyamides, polyimides, styrenic block copolymers, nitrile rubber, etc.

In addition, 3D printing also is applicable to ceramic materials for manufacturing bioceramics as well as technical ceramics. For example, bioceramics may be 3D printed for use as dental implants and appliances, hip, and knee implants or for bone regeneration and reconstruction. Technical ceramics maybe used in engineering as pistons, bearing, nozzles, etc.

However, resins used for 3D printing ceramic objects include resins with ceramic suspensions. That is, these resins include photosensitive polymers with fine ceramic particles suspended therein. The suspensions are preferably stable, and the ceramic particles are preferably homogeneously and effectively dispersed in the photopolymerisable medium for successful 3D printing of the resulting ceramic objects.

In some cases, the ceramic particles may include micro- and/or nano-ceramic particles. In addition, in some cases, the resins may include over 50% inorganic ceramic content. As such, the viscosity of the ceramic particle laden resin is high.

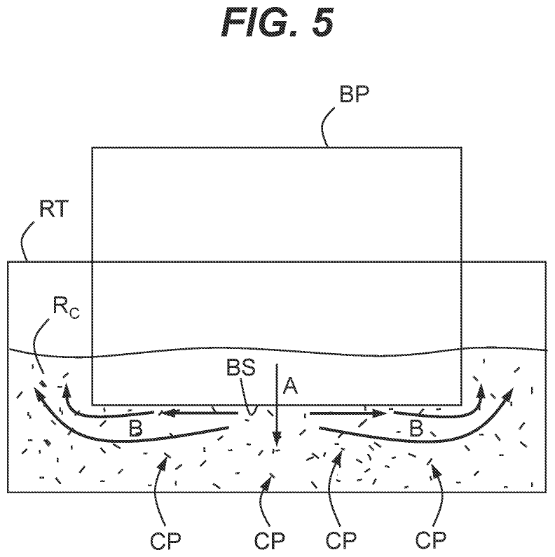

FIG. 5 shows the setup of FIG. 1 with the resin R_{C} including a photosensitive polymer with suspended fine ceramic particles CP. As the build platform BP is lowered into the resin tank RT, the resin R_{C} in contact with the build surface BS is pushed downward and forced to flow outwards across the build surface BS until the positioning is complete. This resin flow is represented by the arrows B.

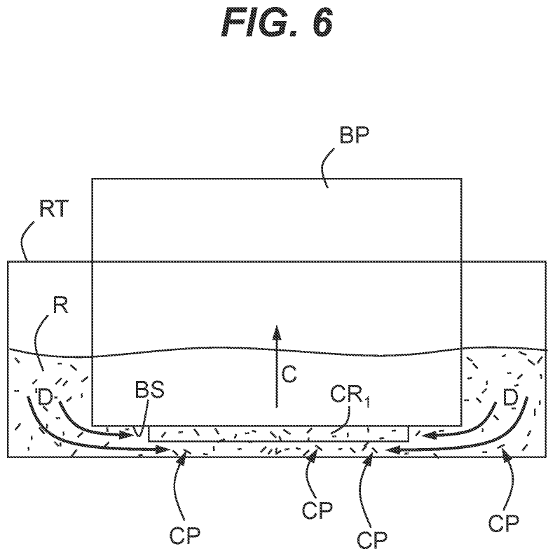

In addition, as shown in FIG. 6, as the build platform BP is raised in-between the printing of each layer of cured resin CR (as represented by the arrow C), the resin R_{C} flows from the sides of the build platform BP down and across the platform's build surface BS and into the area beneath the first layer of cured resin CR1 as indicated by the arrows D.

During repeated operation of the 3D printing system using ceramic laden resin R_{C}, the inventor, upon comparing a number of sequentially printed objects, discovered that the coloration of the objects shifted slightly between the first parts printed to the final parts printed using the recycled resin R_{C} within the resin tank RT. Upon this discovery, the inventor carefully analyzed the various elements of the 3D printing system, including the build surface BS and the resin R_{C} used during the printing cycles.

In a first example, upon analyzing the build surface BS under a microscope, the inventor discovered micro-scratches (unperceivable to the naked eye) in the build surface BS. In addition, upon analyzing the resin R_{C} left within the resin tank RT after the printing cycles were completed, the inventor discovered micro-particles of aluminum (the build surface material) within the resin R_{C}. Furthermore, upon analyzing the 3D printed parts, the inventor discovered that the parts included micro-particles of aluminum that the inventor theorized caused the shifts in the parts' colorations.

The inventor then ascertained, using the discoveries described above, that during the repeated cycling of the 3D printing system and the resulting resin flows within the resin tank caused by the repeated movement of the build platform BP, that the ceramic particles CP within the highly viscous flowing resin R_{C} are caused to continually scrape across the build surface BS, causing micro-scratches in the surface BS and dislodging micro-particles of the build surface's material (e.g., aluminum) into the resin R_{C}.

Upon these discoveries, the inventor studied the hardness of the build surface BS and that of the ceramic particles CP within the resin R_{C} and discovered that the ceramic particles CP have a Mohs hardness rating of about 7.5 while the aluminum build surface BS has a Mohs hardness rating of only about 2.5-2.75.

The inventor then theorized that this problem may be solved by creating a build platform BP with a build surface BS that has an equal or higher Mohs hardness rating than that of the ceramic particles CP. This is described below.

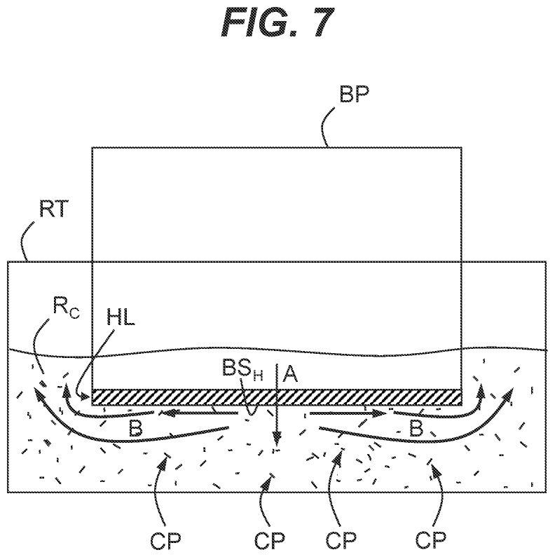

In some embodiments, as shown in FIG. 7, the build platform BP includes a lower hardened layer HL thereby providing a hardened build surface BS_{H}.

In some embodiments, the hardened layer HL is formed directly from the build platform BP, e.g., by anodizing the platform's bottom build surface BS. The aluminum build surface BS is immersed into an acid electrolyte bath and current is passed through the medium. A cathode is mounted to the inside of the anodizing tank such that the aluminum build surface BS acts as an anode. Negatively charged oxygen ions are released from the electrolyte that combine with the positively charged aluminum atoms at the build surface BS thereby creating a layer of strongly adherent aluminum oxide (Al₂O₃) at the surface BS.

In some embodiments, the hardened build surface BS_{H} is anodized to a Type III hardcoat anodization wherein the anodized hardened layer HL is about 0.0005″ to 0.0060″ thick (about 13 nm to 150 nm). This provides a thick layer of Al₂O₃ as the hardened build surface BS_{H} having a Mohs hardness rating of about 9.

As such, the hardness of the hardened layer HL of the hardened build surface BS_{H} (Mohs hardness of about 9) is harder than the ceramic particles CP (Mohs hardness of about 7.5) within the resin RC. Upon using the hardened build surface BS_{H} through multiple cycles of 3D printing, the inventor found that the micro-scratches on the build surface BS and the micro-particles released into the resin R_{C} were no longer present. As such, the hardened build surface BS_{H} solved the problem discovered by the inventor.

It is understood that Type I and Type II anodization methods resulting in thinner anodized layers also may be used.

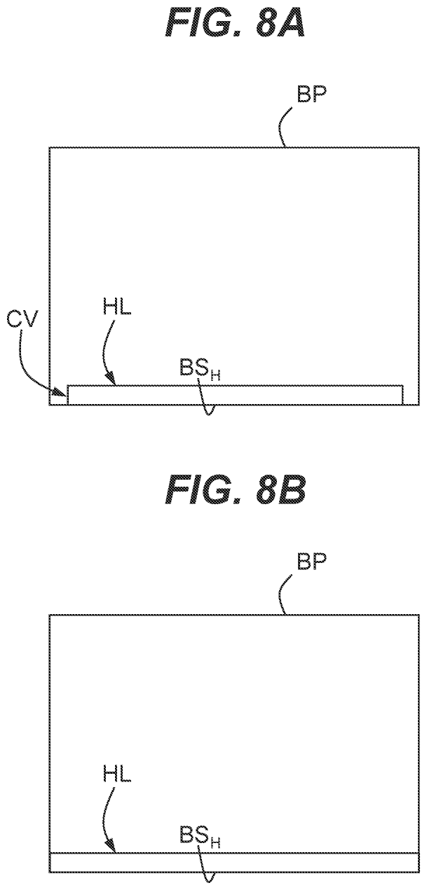

In another embodiment, as shown in FIGS. 8A-8B, the hardened layer HL of the build surface BS may include a sheet of hard material attached to the underside of the build platform BP that may act as the build surface BS. In some embodiments, the hardened layer HL may include a sheet of material that includes a Mohs hardness rating equal to or greater than that of the ceramic particles CP in the resin RC.

In a first example, the hardened layer HL may include a sheet of ceramic or glass. Other materials, preferably with a Mohs hardness equal to or greater than that of the ceramic particles CP, also may be used.

In some embodiments, as shown in FIG. 8A, the hardened layer HL is embedded into an underneath side cavity CV in the build platform BP. In some embodiments, the hardened layer HL may be secured within the cavity using pressure fit, adhesive, detents, bolts, screws, using other attachment mechanisms, and any combinations thereof. It may be preferable that the build surface BS formed as the bottom surface of the hardened layer HL be generally flush or positioned below the bottom sides of the build platform BP surrounding the cavity CV.

In some embodiments, as shown in FIG. 8B, the hardened layer HL may be secured directly to the bottom surface of the build plate BP (not within a cavity) using adhesive, detents, bolts, screws, using other attachment mechanisms, and any combinations thereof.

In another aspect of the invention, the inventor discovered that the hardened build surface BS_{H} may include a lesser surface energy than that of the softer (e.g., aluminum) build surfaces BS. As such, the adhesion of the 3D printed part to the hardened build surface BS_{H} (which is dependent on the build surface's surface energy) also may be less compared to its adhesion to the softer build surfaces BS. If this adhesion between the 3D printed part and the build surface BS_{H} is less than the adhesion between the 3D printed part and the optically clear film used as the bottom surface of the resin tank RT, the printing process may be unsuccessful.

To counter this, the inventor increased the overall adhesive force between the 3D printed part and the hardened build surface BS_{H} by increasing the surface area of contact between the printed part and the surface BS_{H}.

The overall adhesive force between the 3D printed part and the hardened build surface BS_{H} may be described as:

F=k*(Surface Tension)*(Surface Area)
where k is a constant

In a first example, the surface area of contact was increased by roughing the hardened build surface BS_{H}. By purposely roughing the hardened build surface BS_{H}, the surface area of contact between the surface BS_{H} and the 3D printed part may be increased. In some embodiments, the roughness may be a measure of the average distance between the peaks and valleys on a particular surface. The higher the roughness, the more area is available for the resin R_{C} to flow into before curing. In some embodiments, the inventor has discovered that a surface roughness RA of about 0.5 μm to 10 μm provides a sufficient adhesive force between the hardened build surface BS_{H} and the 3D printed part.

It is understood that any aspect or element of any embodiment described herein or otherwise may be combined with any other aspect or element of any other embodiment to form additional embodiments of the system 10, all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs,” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A build platform for use in a three-dimensional (3D) printing system employing photosensitive resin with particle suspensions, the particles including a first Mohs hardness rating, the build platform comprising:
a build platform including a build surface including a second Mohs rating, the second Mohs rating equal to or greater than the first Mohs rating.

2. The build platform of claim 1 wherein the particles include ceramic particles and the first Mohs rating is about 7.5, and the build surface includes anodized aluminum and the second Mohs rating is about 9.0.

3. The build platform of claim 2 wherein the anodized aluminum is a Type III anodization.

4. The build platform of claim 2 wherein a thickness of the anodized aluminum is about 13 μm to 150 μm.

5. The build platform of claim 1 wherein the build surface is roughened to increase a surface area of contact between the build surface and a 3D printed part.

6. The build platform of claim 4 wherein the build surface is roughened to include a roughness rating RA of about 0.5 μm to 10 μm.
